(19) United States
(12) Patent Application Publication
(10) Pub. No.: US 2011/0050730 A1
(43) Pub. Date: Mar. 3, 2011

(54) Method of displaying data on a portable electronic device according to detected movement of the portable electronic device

(76) Inventors: Paul Ranford, Auckland (NZ); Rodney Macfarlane, Auckland (NZ)

(21) Appl. No.: 12/550,418

(22) Filed: Aug. 31, 2009

(51) Int. Cl. G09G 5/00; G06F 3/048

(52) U.S. Cl. 345/660; 345/184; 715/784

(57) ABSTRACT

A method of viewing data on a portable electronic device includes presenting data on a display of the portable electronic device, the portable electronic device having a sensor for detecting movement of the portable electronic device, the sensor detecting movement of the portable electronic device in a first direction, the first direction being parallel with the horizontal, and scrolling the data presented on the display in the first direction in response to the sensor detecting movement of the portable electronic device in the first direction.

### BACKGROUND OF THE INVENTION

1. Field of the Invention

The invention relates to a method of interactively displaying data on a portable electronic device, and more particularly, to a method of interactively displaying data on a display of a portable electronic device in response to detected movement of the portable electronic device.

2. Description of the Prior Art

With the widespread adoption of powerful portable electronic devices such as smart phones and personal digital assistants (PDAs), more people are using portable electronic devices to listen to music, store a calendar, and view documents and maps. In order to design portable electronic devices having small sizes, the displays used on the portable electronic device are limited in size as well. As a result, viewing data such as documents and maps can be more challenging on a small display than it would be if viewed on a larger display, such as the display of a desktop computer.

For example, when viewing a document or a map on a portable electronic device, scrolling and zooming can be slow and complicated procedures. In addition, viewing maps on the portable electronic device is also limited to viewing the maps in two dimensions. In view of the above shortcomings of conventional technology, there remains a need for an improved method of scrolling, zooming, and changing viewing angles when viewing items on a portable electronic device.

### SUMMARY OF THE INVENTION

It is therefore one of the primary objectives of the claimed invention to provide methods for scrolling, zooming, and changing the viewing angle of data shown on a display of a portable electronic device according to detected movement of the portable electronic device.

According to an exemplary embodiment of the claimed invention, a method of viewing data on a portable electronic device is disclosed. The method includes presenting data on a display of the portable electronic device, the portable electronic device having a sensor for detecting movement of the portable electronic device, the sensor detecting movement of the portable electronic device in a first direction, the first direction being parallel with the horizontal, and scrolling the data presented on the display in the first direction in response to the sensor detecting movement of the portable electronic device in the first direction.

According to another exemplary embodiment of the claimed invention, a method of viewing data on a portable electronic device is disclosed. The method includes presenting data on a display of the portable electronic device, the portable electronic device having a sensor for detecting movement of the portable electronic device, the sensor detecting movement of the portable electronic device in a first direction, the first direction being perpendicular with the horizontal, and zooming the data presented on the display in response to the sensor detecting movement of the portable electronic device in the first direction.

According to yet another exemplary embodiment of the claimed invention, a method of viewing data on a portable electronic device is disclosed. The method includes presenting data on a display of a portable electronic device, the portable electronic device having a sensor for detecting movement of the portable electronic device, the sensor detecting movement of the portable electronic device in a first direction, the first direction tilting with respect to the horizontal, and adjusting an angle in which the data is presented on the display in response to the sensor detecting movement of the portable electronic device in the first direction.

It is an advantage that a user of the portable electronic device can simply move the portable electronic device in order to control the way that data is shown on the display of the portable electronic device. In this way, the user can quickly change to a different view without having to use slower conventional input methods, such as by touching a touch screen of the portable electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is shows a top view of a portable electronic device according to the present invention.

FIG. 2 shows a bottom view of the portable electronic device.

FIG. 3 shows the act of scrolling data shown on the display of the portable electronic device.

FIGS. 4-6 show the act of zooming data shown on the display of the portable electronic device.

FIGS. 7-10 show the act of adjusting an angle in which data is presented on the display of the portable electronic device.

### DETAILED DESCRIPTION

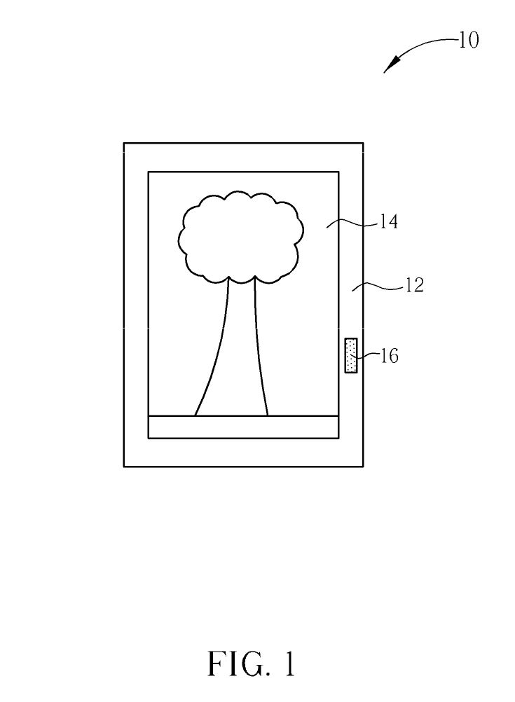

The present invention provides several convenient new ways of changing the view of data shown on a display of a portable electronic device. Please refer to FIG. 1. FIG. 1 is shows a top view of a portable electronic device 10 according to the present invention. The portable electronic device 10 contains a housing 12, a display 14 disposed on the housing 12, and a lock button 16 for locking the view in a current viewing state. In order to change the view of an image, document, or map shown on the display 14, a user physically moves the portable electronic device 10 in one of several different ways, as will be explained below.

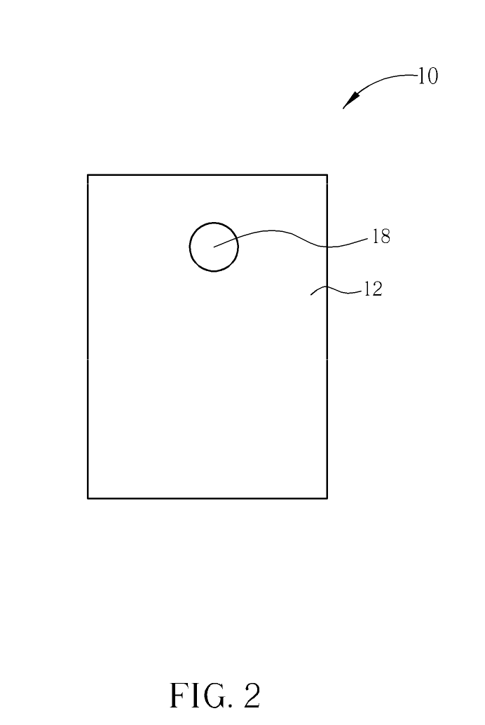

Please refer to FIG. 2. FIG. 2 shows a bottom view of the portable electronic device 10. The portable electronic device 10 contains a sensor 18 for detecting movement of the portable electronic device 10. The sensor 18 may be formed on a bottom side of the housing 12 or may be formed within the housing 12, depending on the type of sensor 18 used. The sensor 18 can detect movement in a variety of different directions, such as up, down, left, right, rotating left or right in the horizontal plane, or tilting in any direction. When movement is detected in a particular direction, the image shown on the display 14 is changed accordingly.

The sensor 18 may contain a camera or an optical sensor located on the bottom side of the housing 12. When the portable electronic device 10 is placed on the surface of another object, such as a table or a desk, the portable electronic device 10 is positioned with the display 14 facing up and with the sensor 18 facing the surface of the object. The sensor 18 detects movement of the portable electronic device 10 by capturing a series of images and processing these images for determining if the portable electronic device 10 has moved from one position to another. The portable electronic device 10 is not limited to being placed on the surface of another object in order for the sensor 18 to work. The sensor 18 can still capture images when the portable electronic device 10 is lifted up away from the surface of the object or even when the portable electronic device 10 is tilted or rotated in any direction.

Besides using a camera or an optical sensor, the sensor 18 can also utilize an accelerometer or a gyroscope instead. One or multiple sensor 18 can be used to detect movement of the portable electronic device 10 in any direction. The accelerometer or gyroscope does not need to be installed on a bottom side of the portable electronic device 10, and can instead be formed within the housing 12.

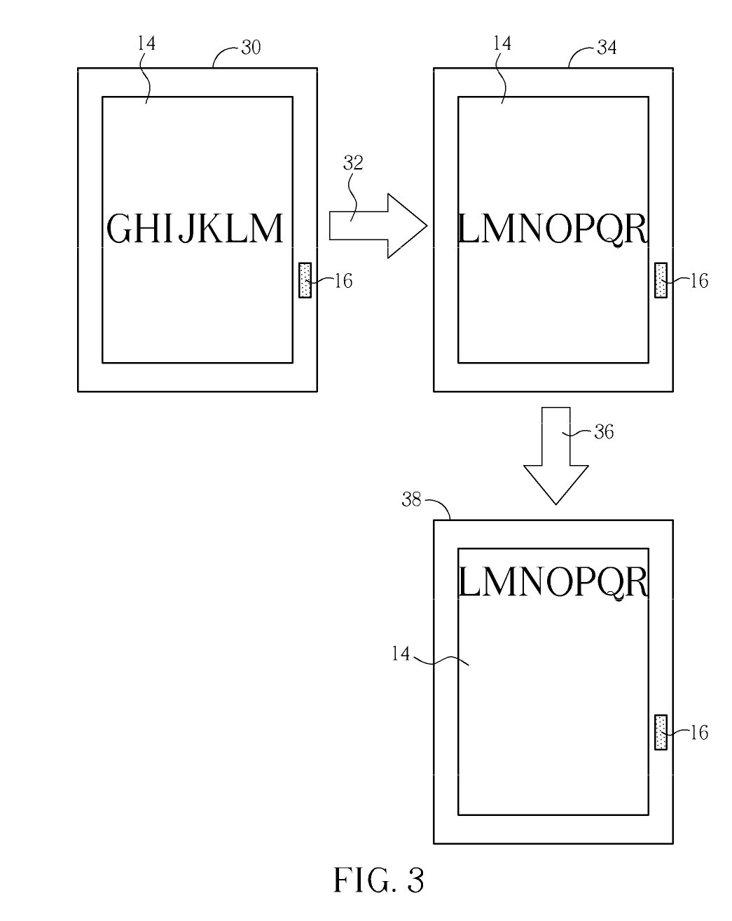

Please refer to FIG. 3. FIG. 3 shows the act of scrolling data shown on the display 14 of the portable electronic device 10. In FIG. 3, the portable electronic device 10 starts at position 30, moves along direction 32 to position 34, and then moves along direction 36 to position 38. At position 30, text shown on the display 14 reads “GHIJKLM”. When the portable electronic device 10 is moved to the right along direction 32 to position 34, the sensor 18 detects movement of the portable electronic device 10 and controls the text shown on the display 14 to simultaneously scroll to the right as the portable electronic device 10 is moved. At position 34, text shown on the display 14 reads “LMNOPQR”. Then, when the portable electronic device 10 is moved down along direction 36 to position 38, the sensor 18 detects movement of the portable electronic device 10 and controls the text shown on the display 14 to simultaneously scroll down as the portable electronic device 10 is moved. In this way, the user can easily scroll data shown on the display 14 in a particular direction by simply moving the portable electronic device 10 in the same direction.

If the user wishes to move the portable electronic device 10 without changing the view of data currently being shown on the display 14, the user can simply press and hold the lock button 16 while moving the portable electronic device 10 in any direction. The lock button 16 can be useful if the user needs to walk from one spot to another without changing the data shown on the display 14. Also, the lock button 16 can be used for scrolling a great deal in one direction, where the amount of scrolling required exceeds the amount of surface space available on the desk or table that the portable electronic device 10 is resting upon. In situations like this where the user wishes to scroll a significant amount to the right, the user can first move the portable electronic device 10 to the right in order to scroll to the right a first amount, then press and hold the lock button 16 while moving the portable electronic device 10 back to the left. Then the user can release the lock button 16 and move the portable electronic device 10 to the right in order to scroll to the right a second amount.

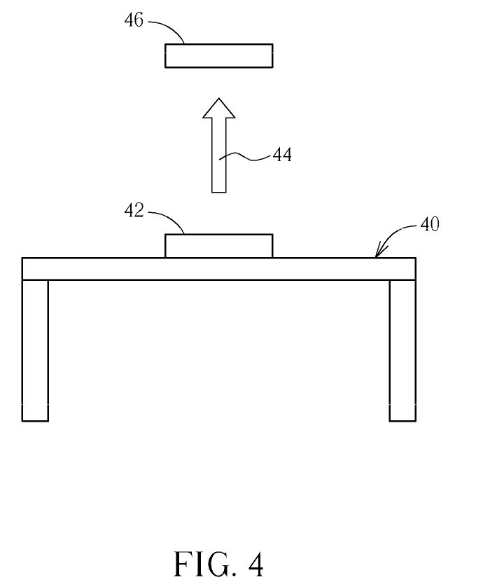

Please refer to FIGS. 4-6. FIGS. 4-6 show the act of zooming data shown on the display 14 of the portable electronic device 10. In FIG. 4, the portable electronic device 10 rests on the surface of a table 40 at position 42. Then the portable electronic device 10 is raised up along direction 44 to position 46. Lifting up or lowering the portable electronic device 10 changes the zoom level of data shown on the display 14 in a manner similar to how moving a magnifying glass towards or away from an object affects the magnification of the object shown in the magnifying glass. If the user is looking down at the display 14 of the portable electronic device 10, lowering the portable electronic device 10 zooms in on the data being shown, whereas lifting up the portable electronic device 10 zooms out on the data being shown.

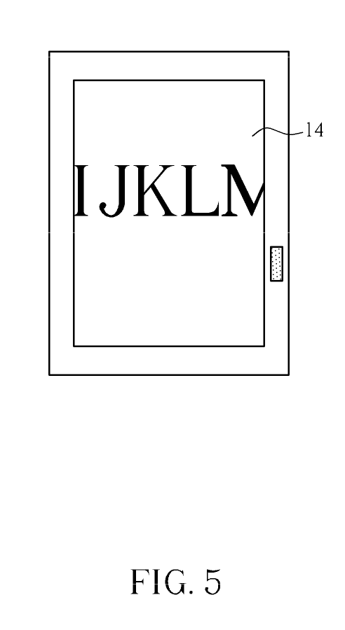

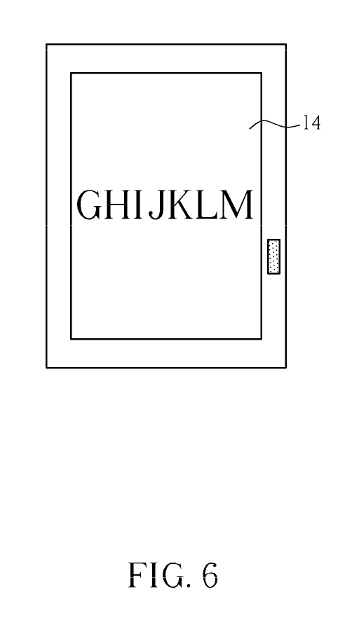

The zoom levels of data shown in FIG. 5 and FIG. 6 correspond to positions 42 and 46 of FIG. 4, respectively. At position 42, the portable electronic device 10 is lower than in at position 46, and thus the text is zoomed in at a greater zoom level in FIG. 5 than it is in FIG. 6. The sensor 18 detects movement of the portable electronic device 10 in the up or down directions, and the zoom level of data shown on the display 14 is adjusted accordingly.

As was the case with the scroll movement, if the user wishes to move the portable electronic device 10 without changing the view of data currently being shown on the display 14, the user can simply press and hold the lock button 16 while moving the portable electronic device 10 in any direction. With the zoom function, the lock button 16 can be useful if the user needs to walk from one spot to another without changing the data shown on the display 14. Also, the lock button 16 can be used for zooming in or zooming out a great deal, where the amount of zooming required exceeds the amount of distance that the user can reasonably lift or lower the portable electronic device 10. In situations like this where the user wishes to zoom in a significant amount, the user can first lower the portable electronic device 10 as much as possible to zoom in a first amount, then press and hold the lock button 16 while raising the portable electronic device 10 back up. Then the user can release the lock button 16 and lower the portable electronic device 10 in order to zoom in a second amount.

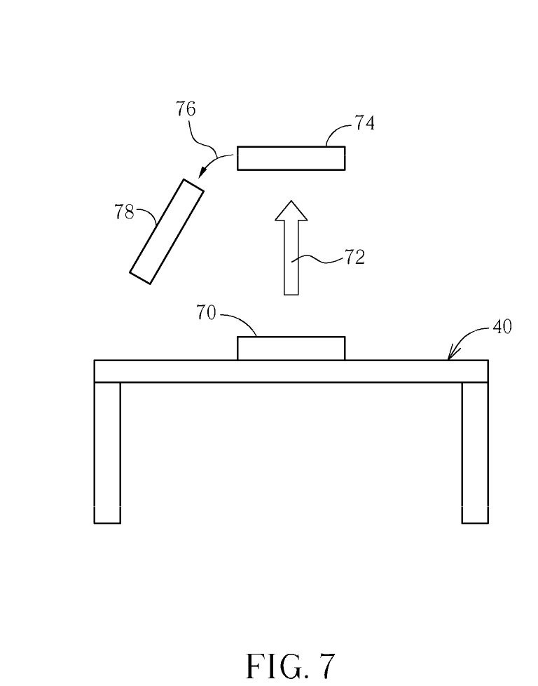

Please refer to FIGS. 7-10. FIGS. 7-10 show the act of adjusting an angle in which data is presented on the display 14 of the portable electronic device 10. In FIG. 7, the portable electronic device 10 rests on the surface of the table 40 at position 70. Then the portable electronic device 10 is raised up along direction 72 to position 74. As mentioned previously, lifting up or lowering the portable electronic device 10 changes the zoom level of data shown on the display 14. Next, the portable electronic device 10 is moved and tilted along direction 76 to position 78. The act of tilting the portable electronic device 10 from the horizontal plane to a different plane changes the view of objects shown on the display 14 from a two-dimensional, top-down view of the objects into a three-dimensional, perspective view or side view of the objects.

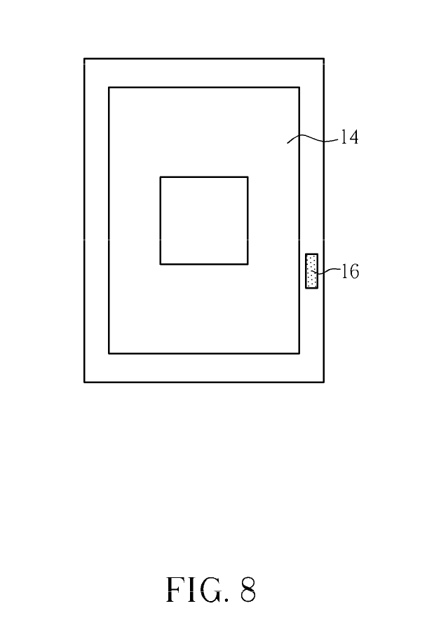

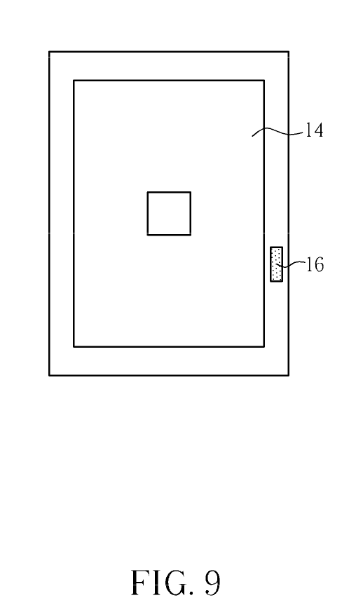

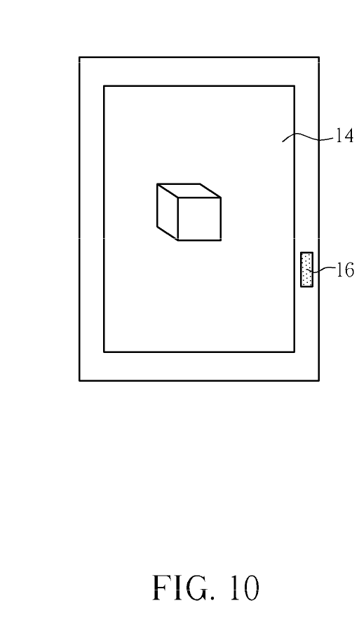

The views shown in FIGS. 8-10 correspond to positions 70, 74, and 78 of FIG. 7, respectively. At position 70, the portable electronic device 10 is lower than in at position 74, and thus the object shown in the display 14 is zoomed in at a greater zoom level in FIG. 8 than it is in FIG. 9. The sensor 18 detects movement of the portable electronic device 10 in the up or down directions, and the zoom level of data shown on the display 14 is adjusted accordingly. Then, the sensor 18 detects movement of the portable electronic device 10 from position 74 to position 78, which represents a tilting movement of the portable electronic device 10. The sensor 18 detects the angle of the portable electronic device 10, and accordingly adjusts the angle at which the object is shown on the display 14. Thus, the top-down, two-dimensional view shown in FIG. 9 is changed to a three-dimensional, perspective view shown in FIG. 10.

As with the scroll and zoom movements mentioned above, if the user wishes to move the portable electronic device 10 without changing the view of data currently being shown on the display 14, the user can simply press and hold the lock button 16 while moving the portable electronic device 10 in any direction. The ability to zoom in or out and change the viewing angle of a map or object allows the user to explore objects in three dimensions. When the user is viewing a three-dimensional map, the user can look around buildings, zoom in or out, and change the viewing angle by simply moving the portable electronic device 10 around in space.

Other movements or gestures can also be used to control the way that data is viewed on the display 14 of the portable electronic device 10. For instance, gestures such as a quick flick of the wrist can be used to perform a corresponding action. Additionally, other useful functions include rotating the view by 90, 180, or 270 degrees when another movement is detected.

In summary, the present invention method provides a natural and convenient way to view data and objects on a portable electronic device 10 without requiring the user to use a slow interface for changing the viewing mode of the data being viewed.

Those skilled in the art will readily observe that numerous modifications and alterations of the device and method may be made while retaining the teachings of the invention.

What is claimed is:

1. A method of viewing data on a portable electronic device, the method comprising:
presenting data on a display of the portable electronic device, the portable electronic device having a sensor for detecting movement of the portable electronic device;
the sensor detecting movement of the portable electronic device in a first direction, the first direction being parallel with the horizontal; and
scrolling the data presented on the display in the first direction in response to the sensor detecting movement of the portable electronic device in the first direction.

2. The method of claim 1, wherein the sensor comprises a camera capturing a series of images for detecting movement of the portable electronic device in the first direction.

3. The method of claim 1, wherein the sensor comprises an optical sensor capturing a series of images for detecting movement of the portable electronic device in the first direction.

4. The method of claim 1, wherein the sensor comprises an accelerometer or a gyroscope for detecting movement of the portable electronic device in the first direction.

5. The method of claim 1 further comprising:
a lock button for preventing the data from being scrolled on the display when the lock button is activated and the sensor detects movement of the portable electronic device.

6. The method of claim 1, wherein the portable electronic device rests on a surface of an external object and the sensor is located on a bottom side of the portable electronic device facing the surface of the external object.

7. A method of viewing data on a portable electronic device, the method comprising:
presenting data on a display of the portable electronic device, the portable electronic device having a sensor for detecting movement of the portable electronic device;
the sensor detecting movement of the portable electronic device in a first direction, the first direction being perpendicular with the horizontal; and
zooming the data presented on the display in response to the sensor detecting movement of the portable electronic device in the first direction.

8. The method of claim 7, wherein the first direction is up from the horizontal, and zooming the data presented on the display comprises zooming out on the data presented on the display.

9. The method of claim 7, wherein the first direction is down towards the horizontal, and zooming the data presented on the display comprises zooming in on the data presented on the display.

10. The method of claim 7, wherein the sensor comprises a camera capturing a series of images for detecting movement of the portable electronic device in the first direction.

11. The method of claim 7, wherein the sensor comprises an optical sensor capturing a series of images for detecting movement of the portable electronic device in the first direction.

12. The method of claim 7, wherein the sensor comprises an accelerometer or gyroscope for detecting movement of the portable electronic device in the first direction.

13. The method of claim 7 further comprising:
a lock button for preventing the data from being zoomed on the display when the lock button is activated and the sensor detects movement of the portable electronic device.

14. A method of viewing data on a portable electronic device, the method comprising:
presenting data on a display of a portable electronic device, the portable electronic device having a sensor for detecting movement of the portable electronic device;
the sensor detecting movement of the portable electronic device in a first direction, the first direction tilting with respect to the horizontal; and
adjusting an angle in which the data is presented on the display in response to the sensor detecting movement of the portable electronic device in the first direction.

15. The method of claim 14, wherein the angle in which data is presented on the display is adjusted in an identical manner corresponding to the movement of the portable electronic device in the first direction.

16. The method of claim 14, wherein when the display of the portable electronic device is not parallel with the horizontal, the data presented on the display is shown in a three-dimensional view.

17. The method of claim 14, wherein the sensor comprises a camera capturing a series of images for detecting movement of the portable electronic device in the first direction.

18. The method of claim 14, wherein the sensor comprises an optical sensor capturing a series of images for detecting movement of the portable electronic device in the first direction.

19. The method of claim 14, wherein the sensor comprises an accelerometer or gyroscope for detecting movement of the portable electronic device in the first direction.

20. The method of claim 14 further comprising:
a lock button for preventing an angle in which the data is presented on the display from being adjusted when the lock button is activated and the sensor detects movement of the portable electronic device.
